(19) United States
(12) Patent Application Publication
(10) Pub. No.: US 2005/0140164 A1
(43) Pub. Date: Jun. 30, 2005

(54) Vehicle having a roof assembly and such roof assembly

(76) Inventors: Bernd Wilms, Nettetal (DE); Pascal Josef Maria Feijts, Roermond (NL)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(21) Appl. No.: 10/507,542

(22) PCT Filed: Mar. 11, 2003
(86) PCT No.: PCT/EP03/50056

(30) Foreign Application Priority Data
Mar. 14, 2002 (DE) 202041107

(51) Int. Cl. B60J 7/00

(52) U.S. Cl. 296/107.18

(57) ABSTRACT

A vehicle has a roof assembly (4) opening an opening (17) in the vehicle roof which includes at least a rear cross beam (12). The roof assembly comprises at least one closure element (8,9,10) which is at least one closure element (8,9,10) which is at least movable between a closed position for closing the roof opening, and an open, rearwardly displaced position, in which the roof opening is at least partially released. The rear cross beam (12) is connected to pivotable arms (13) which are at least pivotally attached to the body (1). The at least one closure element (8,9,10), when in the open position, forms a unit (15) with said rear cross beam (12). The unit (15) is pivotable by means of said arms (13) between an operative position at the roof and an inoperative position in the trunk (3) of the vehicle.

The present invention relates to a vehicle according to the preamble of the claim 1.

Such vehicle is known in various embodiments. The known roof assemblies include rigid panels or foldable covers adapted to move in different fashion.

The object of the present invention is to provide a vehicle having extended possibilities of opening the roof.

For this purpose, the vehicle has the features according to the characterising portion of claim 1.

Due to the invention it is possible to open the roof of the vehicle to a very large extent by moving the at least one closure element and the rear cross beam away into the trunk of the vehicle.

In an advantageous embodiment the unit is positioned at the bottom of the trunk when in its inoperative position, and preferably the trunk comprises a bottom hatch below which the unit is positioned upside down when in its inoperative position.

Due to these features, the movement of the unit can be quite simple, i.e. substantially a rotating movement, while the trunk can still be used when the unit is in its inoperative position.

To obtain a simple movement of the unit by means of the pivotable arms, the vehicle may have a rear window which can be opened for enabling the pivoting movement of the unit to provide even more room for the rotating movement of the unit. It is preferred that the vehicle has a trunk lid to which the rear window is slidably attached, whereas the trunk lid is movably connected to the body on its lower side. This enables the trunk lid and the rear window to move out of the way and enable a wide swing of the unit.

An advantageous embodiment of the vehicle according to the invention is characterised in that the roof assembly includes at least two, and preferable at least three slidable closure elements, preferably rigid panels, lying one behind the other in the closed position of the roof assembly and lying substantially one above the other in the open position. Such multi-element, in particular multi-panel roof offers many choices in opening the roof, so that the roof can be adapted to all kinds of situations or circumstances.

In an advantageous embodiment, the roof assembly includes a rear fixed panel below which the at least one closure element is positioned in the open position of the roof assembly. The fixed panel may be the upper part of a cassette, which is attached to the rear cross beam. The cassette comprises at least one longitudinal guide track extending at least along a side of the cassette and along the roof opening. The at least one closure element is guided by said longitudinal guide track.

In this manner the closure element or elements are moved into the cassette by means of the guide tracks, and the cassette with the closure elements may then be moved into the trunk of the vehicle.

The invention will now be further elucidated with reference to the drawings, showing an embodiment of the vehicle according to the invention.

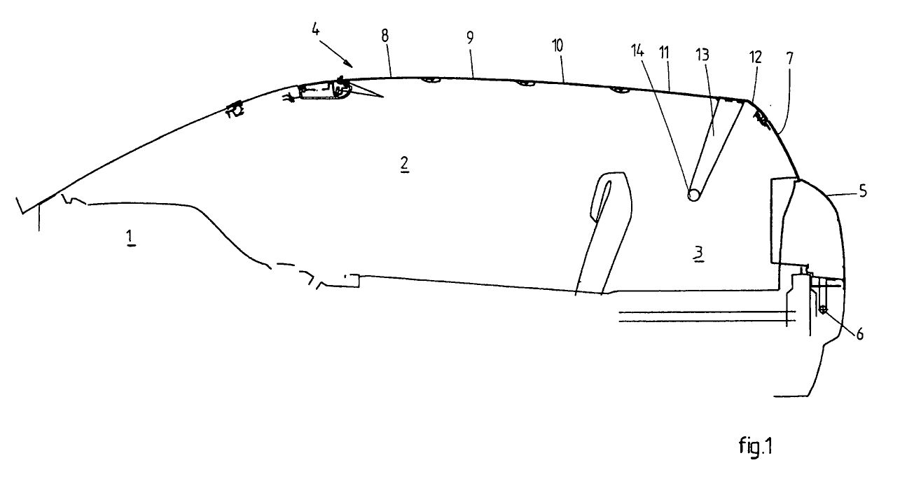

FIG. 1 is a very schematic longitudinal vertical section of a part of the vehicle according to the invention, wherein the roof assembly is in its closed position.

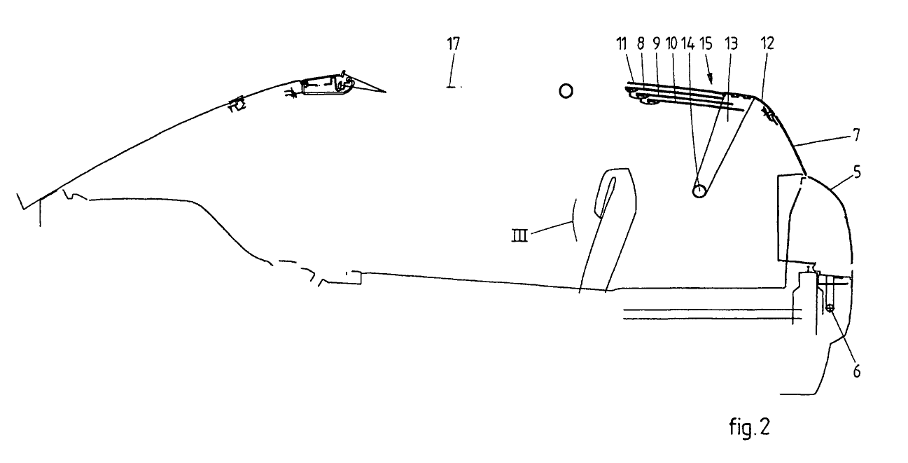

FIG. 2 shows the vehicle of FIG. 1, but with the roof assembly in its open position.

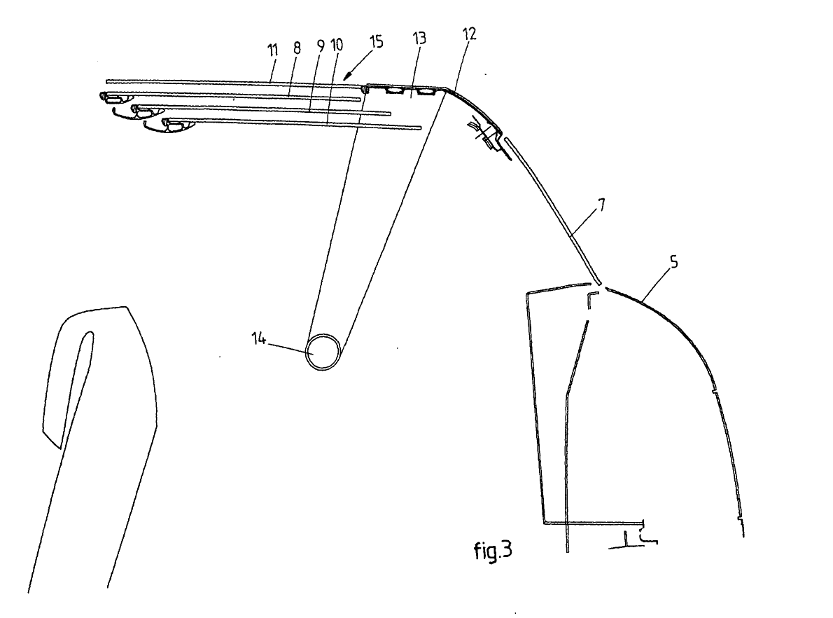

FIG. 3 shows, on a larger scale, detail III in FIG. 2.

FIG. 4 is a view corresponding to that of FIG. 3, but with the rear window opened.

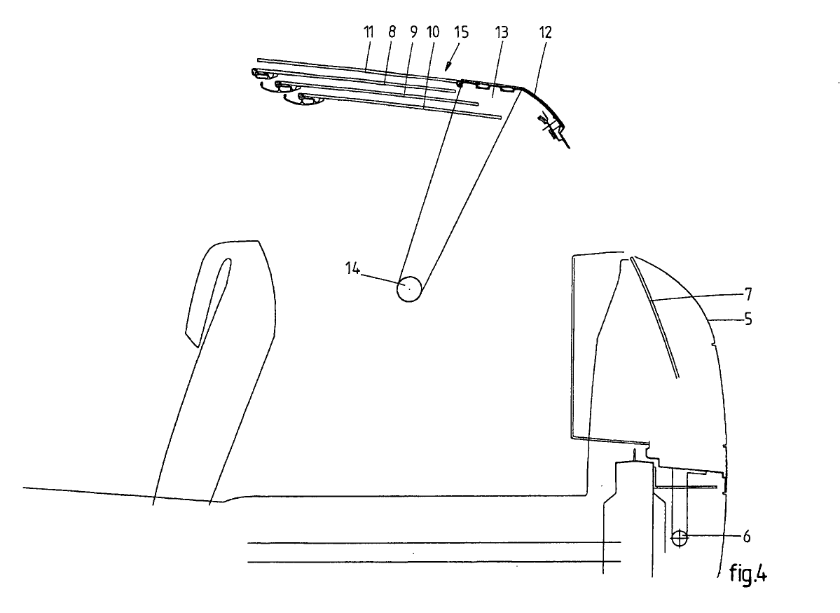

FIG. 5 is a view substantially corresponding to that of FIG. 4 and illustrating the movement of the unit comprising the closure elements and the rear cross beam of the vehicle roof.

FIG. 6 is a perspective view of one half of a vehicle roof comprising a second embodiment of the roof assembly according to the invention, when viewed from above.

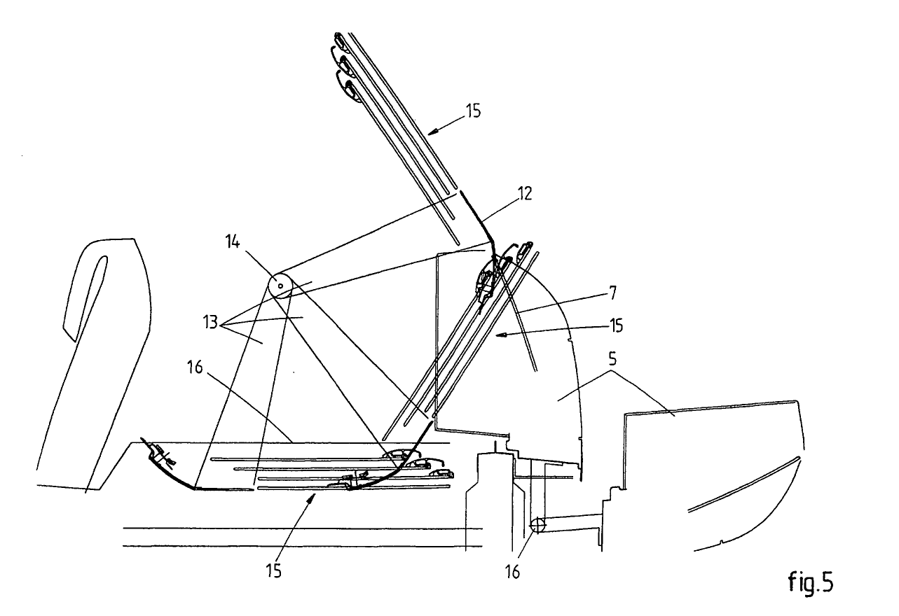

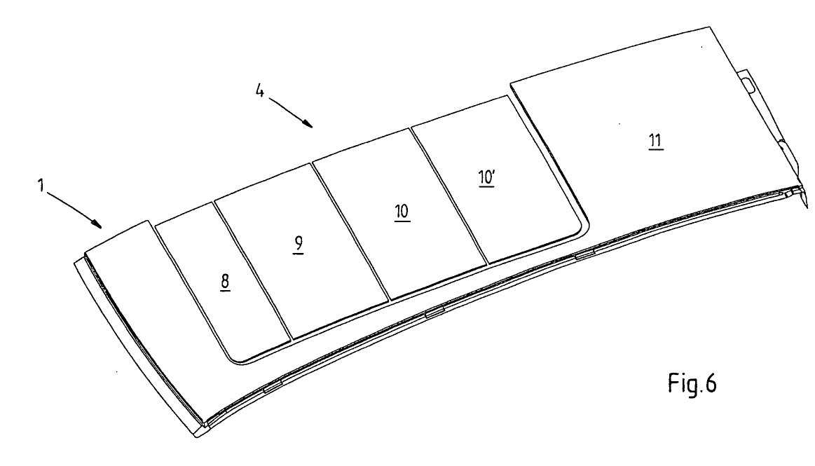

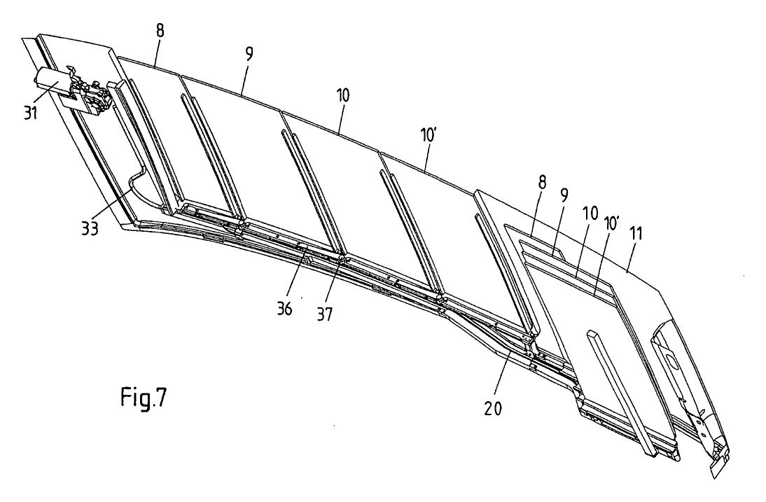

FIG. 7 is a perspective view of the vehicle roof according to FIG. 6, when viewed from below and without interior coverings, the closure elements being shown both in the open and closed positions.

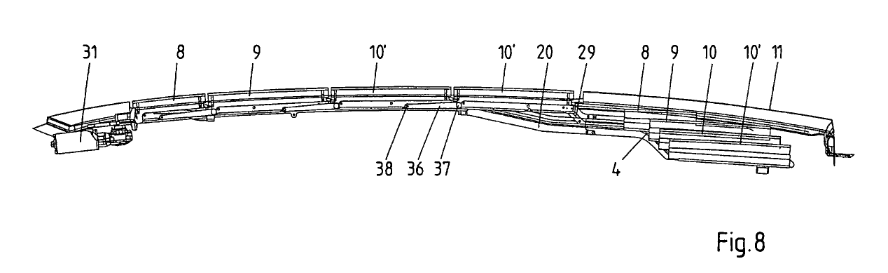

FIG. 8 is a longitudinal sectional view of the fixed roof and closure elements of FIG. 7.

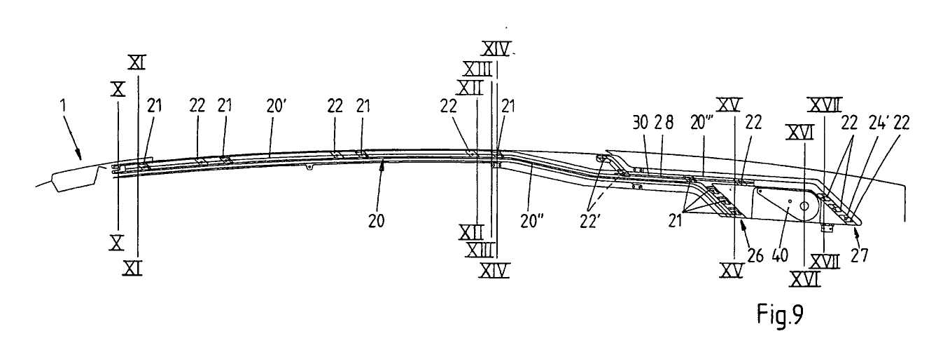

FIG. 9 is a sectional view corresponding to that of FIG. 8, but showing the guide track for the closure elements of FIGS. 6-8.

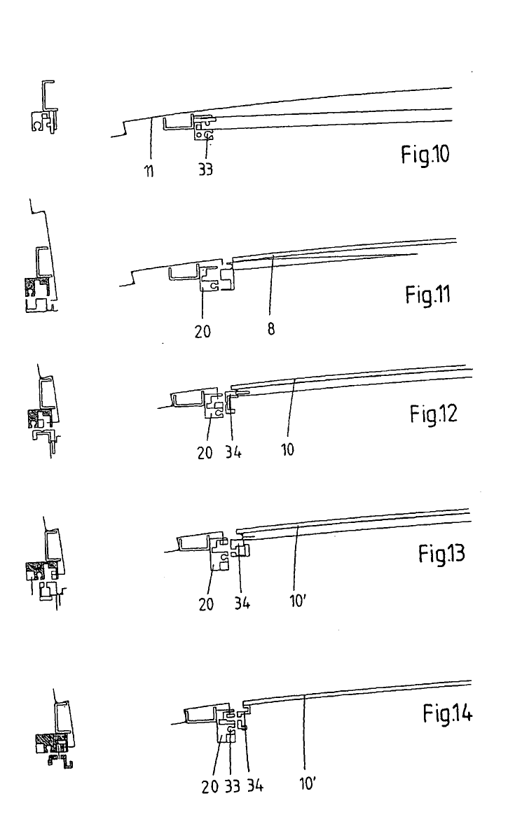

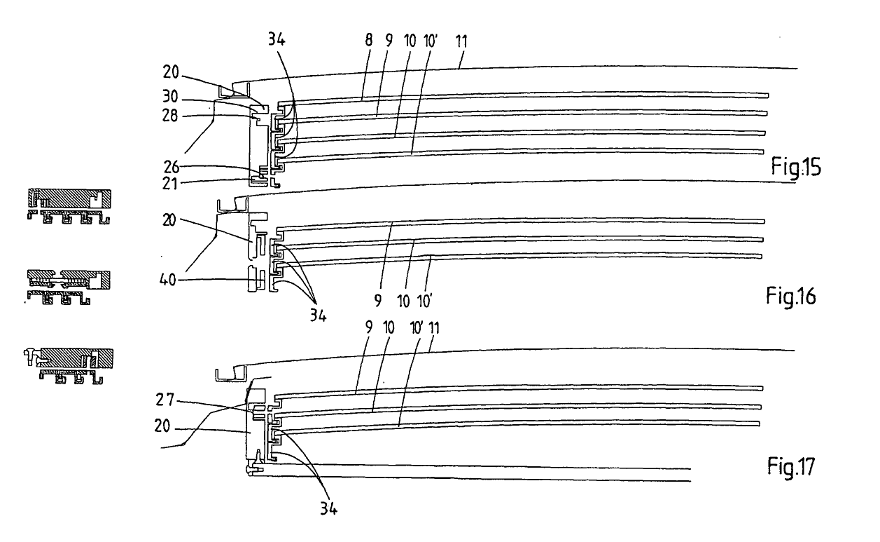

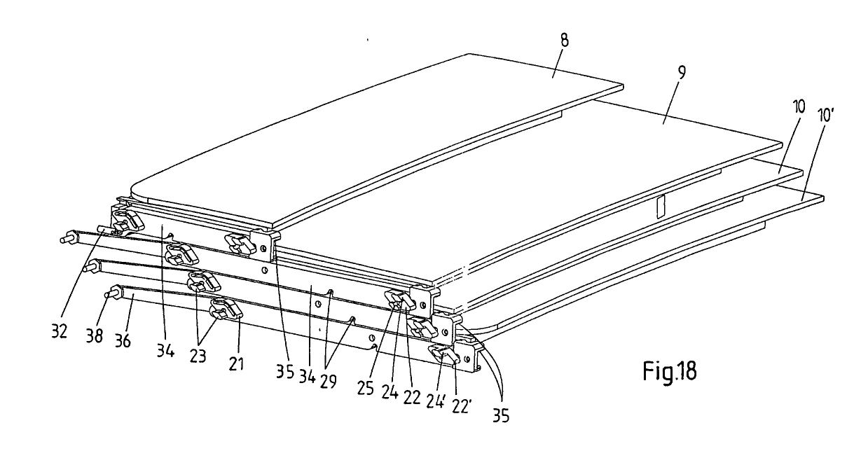

FIGS. 10-17 are sectional views according to the section lines X-X to XVII-XVII in FIG. 9.

FIG. 18 is a perspective view of the stack of closure elements in their open position.

The drawings, and in particular FIG. 1 thereof shows an embodiment of a vehicle, in this case consisting of a passenger car, in particular MPV car. The vehicle includes a body 1 enclosing a passenger compartment 2 and a trunk 3. The body 1 has a roof including a roof assembly 4 to be described hereafter in more detail. The trunk 3 can be opened by means of a trunk lid 5. The lid 5 is connected to the body 1 of the vehicle by means of pivots 6 which are located on the lower side of the trunk lid 5 when in its closed position, so that the trunk lid 5 will move away from the vehicle at its upper side and will present a projecting floor when in its open position. The trunk lid 5 includes a rear window 7 which is slidably attached to the trunk lid such that the rear window 7 will sink away into the trunk lid 5 when it is opened.

The roof assembly for the vehicle comprises in this case three movable closure elements 8, 9, 10 consisting of rigid, preferably at least partly transparent panels. The closure elements 8 are slidably guided in longitudinal guide tracks extending along an opening 17 in the roof and along longitudinal roof beams of the vehicle (not shown). Operating mechanisms will cause the opening and closing movements of the closure elements 8-10 in a manner known from the prior art.

As is shown in FIG. 1 and 2, the movable closure elements 8-10 can be moved from a closed position lying one behind the other to close the roof opening 17, to a stacked position, lying one above the other below a fixed panel closure element 11 which is positioned in front of a rear cross beam 12 of the vehicle roof. The movement of the closure elements 8-10 can be obtained in a manner known per se. For example, it is possible to guide each of the closure elements 8-10 in its own guide track, and it is also conceivable to guide the closure elements through a common guide track to its own stacked position below the fixed panel 11.

As is further shown in FIG. 2, the rear cross beam 12 is attached to the upper end of an arm 13. In fact there are provided two arms 13 on each side of the vehicle and each fixed to a lateral end of the rear cross beam 12. One arm 13 is shown in a very simplified manner as a single piece arm 13 having a fixed pivot 14, but in a practical embodiment the arms 14 may include several parts which may move relatively to each other and which may pivot with respect to a virtual pivot or may perform a combined translating and rotating movement.

FIG. 3 shows the rear portion of the vehicle on a larger scale the closure elements 8-10 are shown in their opened position in which they form a unit with the rear cross beam 12 such that when the rear cross beam 12 is moved by means of the arms 13, the closure elements 8-11 will move along. One possible embodiment is that the guide tracks for the closure elements 8-10 are fixed to the rear cross beam 12 and panel 11 to hold the closure elements 8-10 together during the unitary movements thereof.

In FIG. 4 it is shown that the rear window 7 is slid to its open position within the trunk lid 5 in order to make room for the rear cross beam 12 to move downwardly and rearwardly. In FIG. 5 it is illustrated that the trunk lid 5 together with the rear window 7 are moved to the open position to completely free the path of the unit 15 in order to move from the operative position at the vehicle roof to an inoperative position at the bottom of the trunk 3. In FIG. 5 it is illustrated by three different positions that the arms 13 perform a purely pivoting movement around the pivot 14 but it will be understood that, especially in a first part of the movement from the operative position, the unit might have to make a slight lifting movement in order to release the parts from their respective seals.

In the inoperative position, the unit 15 is lying upside down at the bottom of the trunk 3 and may be covered by a movable bottom hatch 16 acting as the trunk floor when the unit 15 is in the in operable position so that the trunk may still be used for luggage. When the trunk hatch 5 is closed again, the vehicle is ready again for use. The vehicle is then more or less a convertible car of which the roof is opened completely. In order to close the roof again, the sequence of movements is performed in reverse order.

FIGS. 6-18 show a second embodiment of the vehicle and roof assembly according to the invention in more detail. This second embodiment of the roof assembly comprises four moveable closure elements in the form of rigid panels 8, 9, 10, 10′. In this embodiment, the panels 9, 10 and 10′ are of the same size, whereas the front panel 8 is smaller in size, in particular shorter in longitudinal direction of the roof assembly. In the embodiment shown, the panel 11 is fixed to the remainder of the roof (it is a part thereof) and thus cannot be moved away. However, it should be understood that the structure of the second embodiment can easily be integrated in the basic idea of the first embodiment.

FIG. 7 and 8 show these panels 8-10′ both in their closed position, closing the roof opening 17, and in their open position below the fixed panel 11. In this open position, the panels 8-10′ are stacked one on top of the other. The fixed panel 11 is attached to the cross beam and forms the upper part of a cassette (not shown) in which the panels 8-10′ are accommodated in their open position. The structure could be made such that the cassette together with the panels 8-11 may be moved into the trunk of the vehicle in the manner as shown in FIGS. 1-5.

In order to guide the movements of the panels 8-10′, the roof assembly is equipped with longitudinal guide tracks 20, one on each longitudinal side of the roof opening 17 and on each side of the cassette below the fixed panel 11. Each longitudinal guide track 20 could be separated in two parts, one in the cassette below the fixed panel 11 and one at the fixed roof. This could be done to allow the cassette to move away into the trunk together with the panels 8-10′ if they are in the rear part of the guide track 20.

The guide track 20 (only the guide track on one side of the vehicle is discussed) has a front portion 20′ and a rear portion 20′″ at a lower level below the fixed panel 11, as well as an intermediate, inclined portion 20″ connecting the front and rear portions 20′ and 20′″. The level of the front portion 20′ of the guide track 20 is such as to allow the panels 8-10′ to be positioned flush with the fixed roof of the vehicle. The intermediate portion 20″ and the rear portion 20′″ of the guide track 20 allow the panels 8-10′ to move slightly downwardly below the fixed panel 11 in order to enter the cassette.

Each panel 8-10′ has two slide shoes on each side, which engage the guide track 20 in order to allow for the sliding movements. All front shoes 21 of the panels are equally shaped, which shape differ from the shape of the rear shoes 22. The shape of the rear shoe 22′ of the rear panel 10′ differs slightly from the shape of the rear shoes 22 of the other panels 8-10.

The shape of the shoes 21-22 is best shown in FIG. 18. All slide shoes 21-22 are diamond shaped. The front shoes 21 have a long lower lateral projection 23, whereas the rear shoes 22 have an short upper lateral projection 24, whereas the rear shoe 22′ has a long upper lateral projection 24′ which is longer than the projections 24 in lateral direction, and as long as projection 23. The rear shoes 22 also have a short lower projection 25, while the rear shoe 22′ does not have such lower projection.

The different shapes of the front and the rear shoes 21, 22 are intended to ensure correct entrance of the slide shoes 21, 22 into front and rear storage tracks 26 and 27. These storage tracks 26, 27 connect to the longitudinal guide track 20 from below and are inclined rearwardly and downwardly from the guide track 20. These storage tracks 26, 27 are used to obtain the stacking arrangement of the panels 8-10′ in the open position. In order to prevent the rear slide shoes 22 from entering the front storage tracks 26, the guide track 20 comprises a central longitudinal guide rib 28. This guide rib 28 extends from the intermediate portion 20″ of the guide track 20 rearwardly into the rear portion 20′″ up to a point between the front and rear storage tracks 26, 27.

The guide rib 28 is such that the upper lateral projections 24 of the rear shoes 22 are guided above the guide rib 28 thereby preventing a downward movement thereof. The lower lateral projections 23 and 25 of the front and rear slide shoes 21 and 22 run in a separate groove 41 or below the guide rib 28, respectively, preventing an upper movement of the slide shoes 21, 22 during their engagement with the guide rib 28. The groove 40 extends in the guide track 20 and into the front storage track 26 to ensure that the front shoes 21 enter the front storage track 26.

The different shapes of the upper lateral projection 24′ of the rear shoe 22′ of the rear panel 10′ is such as to cause this slide shoe 22′ to enter an upper side branch 29 of the guide track 20. This upper side branch 29 is provided near the front of the rear portion 20′″ of the guide track 20 and is intended to lift the rear end of the rear panel 10′ when the panels 8-10′ are almost in their closed position. This creates the movement of the rear end of the rear panel 10′ to the flush level, since the rear slide shoe 22′ of the rear panel 10′ cannot use the intermediate portion 20″ of the guide track 22 to be moved to the flush level of the closed position. As this rear slide shoe 22′ is the only one without a lower lateral projection 23, 25, it is the only slide shoe that is allowed to be move upwardly during its engagement with the guide rib 28. The deflection of the rear slide shoe 22 into the side branch 29 is caused by the engagement of the longer upper lateral projection 24′ into a deeper guide groove 30 of the guide track 20, leading into the upper side branch 28. None of the other projections engage into this guide groove 30.

In the embodiment shown, only the front panel 8 is driven directly by a driving means, such as an electric motor 31. Normally there is a drive cable between the electric motor 31 and the front panel 8. In the drawings, only a cable shoe 32 connecting the cable to the front panel 8 (FIG. 18) and a cable guide 32 are shown (e.g. FIGS. 7 and 10).

The other panels 9-10′ are driven by the front panel 8. For this purpose, each panel 8-10′ has a side section 34 having a rear driving surface 35 which is adapted to engage the front end of the side section 34 of the next panel 9-10′ when the front panel 8 is moved backwardly by the electric motor 31. There is provided a further connecting member to form a drive connection between the panels 8-10 when the front panel 8 is moved forwardly. This connecting member at the front end of the panels 9-10′ comprises, in this case, an arm 36 which is pivotally connected at its rear end to the respective side section 34 of the respective panel 9-10′ through a transverse axis 37. On its free front end, each arm 36 is provided with a cross pin 38 which is adapted to engage into a recess 39 in the lower side of the side section 34 of a preceding panel 8-10. Each recess 39 extends upwardly and slightly backwardly from the lower side of the side section 34. Each arm 36 is biased in upward direction by a spring member such as a torsion spring (not shown). This biasing force urges a cross pin 38 into the recess 39 if they are aligned.

It is further shown in FIGS. 15-18 that the side sections 34 of the panels 8-10 are of such shape that they engage the side section 34 of the next panel 9-10′ in a sliding manner when they are in a stacked relationship. As a result, the stacked panels 8-10′ form a unit when they are in their open position within the cassette.

FIG. 9 shows a biasing member 40 between the front and rear storage tracks 26 and 27. This biasing member 40 is spring-loaded in upward direction so as to force the panels 9-10′ to move from the storage tracks 26, 27 into the guide track 20 when the front panel 8 is moved from the open position forwardly to the closed position.

The operation of the roof assembly as is follows.

When the panels 8-10′ of the roof assembly are opened, starting from their closed position as shown in FIGS. 6-8, the front panel 8 is driven by the electric motor 31 and therefore slides rearwardly. Due to the driving surfaces 35, the other panels 9-10′ are taken along. The rear panel 10′ can only be moved rearwardly if the rear end is moved downwardly below the fixed panel 11 which is positioned behind the panel 10 when this is in its closed position. Due to the upper side branch 29 of the guide track 20, the rear slide shoe 22 of the rear panel 10′ which engages in the side branch 29, is moved downwardly through the side branch 29 in the direction of the guide track 20. Thus, the rear panel 10′ is enabled to move below the fixed panel 11 and the other panels 8-10 follow the rear panel 10′ when the slide shoes 21, 22 thereof move through the guide track 20.

The rear slide shoe 22′ of the rear panel 10′ is guided past the front storage track 26 due to the engagement of the upper lateral projection 24 with the guide rib 28 in the guide track 20. When the rear slide shoe 22′ has reached the rear end of the guide track 20 and has come into alignment with the rear storage track 27, the front slide shoe 21 of the rear panel 10′ has come into alignment with the front storage track 26. When the rear panel 10′ is pushed further backwardly, it is urged downwardly with its slide shoes 21 and 22′ into the storage tracks 26, 27, guided by the engagement of the projection 23 in the groove 41 in the storage track 26 and by the contact of the rear shoe 22 with the inclined rear wall of the storage track 27.

If the rear panel. 10′ is moved sufficiently downwardly the preceding panel 10 comes out of abutting relationship with the rear panel 10′ and is allowed to slide over the rear panel 10′. Then, the side sections 34 of the rear panel 10′ and of the preceding panel 10 come into sliding engagement with each other.

The described movements repeat for the panels 9 and 10 and when the front panel 8 has entered the rear portion of the guide track 20 within the cassette below the fixed panel 11 all panels 8-10′ are stacked within the cassette. In case the cassette is movable, the cassette with the panels may then be moved into the trunk of the vehicle as explained with reference to FIGS. 1-5.

When the front panel 8 is driven forwardly again it is moved along until the recess 39 in its side section 34 passes the cross pin 38 on the arm of the next panel 9. Due to the upward force of the spring member, the cross pin 38 is forced into the recess 39. Due to this engagement, the panel 9 is moving along with the panel 8. It is first urged out of the storage tracks 26, 27, both by the biasing member 14 and by the connection with the front panel 8. The co-operation between the guide rib 28/groove 41 and the upper and the lower lateral projections 23, 24 and 25, respectively, prevent the slide shoes 21, 22 from entering the front storage track 26 or the upper side branch 29.

This process continues until the rear panel 10′ is moved out of the storage tracks 26, 27. When the rear slide shoe 22′ of the rear panel 10′ approaches the side branch 29, its guide groove 30 urges the rear slide shoe 22′ into the upper side branch 29 due to engagement of the long upper lateral projection 24′ in the guide groove 30. The rear end of the rear panel 10 is then moved quickly upwardly to its closed position during the last sliding movement of the panels. The roof assembly is then in its closed position again. Of course, the seal between the roof opening and the circumference of the panel assembly is such as to allow the various movements of the panels 8-10′.

From the foregoing description it will be clear that the invention provides a vehicle and a roof assembly which has outstanding operating possibilities, a flush exterior design and an advantageous manner of stacking movable closure elements below the fixed panel and, optionally, hiding the unit in the trunk of the vehicle. With the proper design and operating equipment the roof assembly does not require tools or large muscular force to move the unit between the operative and inoperative positions.

The invention is not restricted to the embodiment shown in the drawing and described hereinbefore and may be varied in different manners within the scope of the appended claims. For example, it is possible that the closure element consists of slats or a folding cover, and may also be moved above a fixed roof part in the open position of the roof assembly. In the embodiment of FIG. 6-18, the drive means for the closure elements is positioned at the font of the roof assembly. In the embodiment of FIG. 1-5, the drive means would normally be in the rear part of the roof assembly which is movable.

1. A vehicle having a body including at least a trunk and a roof, and having a roof assembly for opening an opening in said roof which includes at least a rear cross beam, said roof assembly comprising at least one closure element which is at least movable between a closed position for closing the roof opening, and an open, rearwardly displaced position, in which the roof opening is at least partially released, and wherein the rear cross beam is connected to pivotable arms (13) which are at least pivotally attached to the body, said at least one closure element, when in the open position, forming a unit with said rear cross beam, the unit being pivotable by means of said arms between an operative position at the roof and an inoperative position in the trunk of the vehicle.

2. The vehicle according to claim 1, wherein the unit is positioned at the bottom of the trunk when in the inoperative position.

3. The vehicle according to claim 2, wherein the trunk comprises a bottom hatch below which the unit is positioned upside down in the inoperative position.

4. The vehicle according to claim 1, wherein the vehicle has a rear window which can be opened for enabling the pivoting movement of the unit.

5. The vehicle according to claim 4, wherein the vehicle has a trunk lid to which the rear window is slidably attached, said trunk lid being movably connected to the body on its lower side.

6. The vehicle preferably according to claim 1, wherein the roof assembly includes at least two slidable closure elements lying one behind the other in the closed position of the roof assembly and lying substantially one above the other in the open position.

7. The vehicle according to claim 1, wherein the roof assembly includes a rear fixed panel below which the at least one closure element is positioned in the open position of the roof assembly.

8. The vehicle preferably according to claim 7, wherein the fixed panel is the upper part of a cassette, which is attached to the rear cross beam, said cassette comprising at least one longitudinal guide track extending at least along a side of the cassette and along the roof opening, and said at least one closure element being guided by said longitudinal guide track.

9. The vehicle according to claim 8, wherein the closure elements are guided in a common longitudinal guide track (20) by means of slide shoes, the cassette including storage tracks opening into the guide track from below in order to accommodate the slides of the closure elements so as to stack the closure elements one above the other in their open position.

10. The vehicle according to claim 9, wherein the closure elements have front and rear slide shoes, a front portion of the longitudinal guide track extending at a higher level than a rear portion thereof, the rear portion of the longitudinal guide track having an upper side branch to accommodate the rear slide shoe of a rear closure of the closure elements in the closed position of the roof assembly, while all other slide shoes are in the higher front portion of the guide track, the front and rear slide shoes are differently shaped in order to co-operate with parts of the guide track to create different paths for the rear and front slide shoes in the guide track, wherein the slide shoes include projections of different lateral lengths engaging in corresponding grooves in the guide track.

11. The vehicle according to claim 9, wherein a front closure element of the closure elements is operatively connected to a drive, and wherein the closure elements are connected to each other through disconnectable connecting members, which are constructed such that they disconnect the closure elements before they are stacked in the open position, and they connect the closure elements again when they are returned to the closed position, wherein the connecting members are adapted such that they only act when there is exerted a pulling force on the closure elements, while the closure elements are provided with separate pushing surfaces acting to push a preceding closure element when a pushing force is exerted on the closure elements.

12. The vehicle according to any claim 9, wherein the closure elements are provided with guide elements on their side edges in order to allow a preceding closure element to come into sliding engagement with a following closure element when they are positioned one above the other near their open position.

13. The vehicle according to claim 1, wherein the rear cross beam when in its operative position, is sealed with respect to side beams of the roof by seals, said pivotable arms being provided with a mechanism to lift the rear cross beam from its seals before or when it is moved to its inoperative position, wherein a drive for the closure elements is positioned near the rear cross beam.

14. A vehicle having a body including at least a trunk and a fixed roof, and having a roof assembly for opening an opening in said roof, comprising a plurality of closure elements, said closure elements are at least movable between a closed position for closing the roof opening, and an open, rearwardly displaced position substantially below the fixed roof, wherein the roof assembly further comprises at least one common longitudinal guide track extending at least below each side of the fixed panel and along the roof opening, said closure elements being guided by said longitudinal guide track by means of slide shoes, said guide track including storage tracks opening into the guide track from below in order to accommodate the slides of the closure elements so as to stack the closure elements one above the other in their open position below the fixed roof.

15. The vehicle according to claim 14, wherein the closure elements have front and rear slide shoes, a front portion of the longitudinal guide track extending at a higher level than a rear portion thereof, the rear portion of the longitudinal guide track having an upper side branch to accommodate the rear slide shoe of the rear closure in the closed position of the roof assembly, while all other slide shoes are in the higher front portion of the guide track, the front and rear slide shoes being differently shaped in order to co-operate with parts of the guide track to create different paths for the rear and front slide shoes in the guide track.

16. The vehicle according to claim 14, wherein one front closure element is operatively connected to a drive and wherein the closure elements are connected to each other through disconnectable connecting members, which are constructed such that they disconnect the closure elements before they are stacked in the open position, and they connect the closure elements again when they are returned to the closed position, wherein the connecting members are adapted such that they only act when there is exerted a pulling force on the closure elements, while the closure elements are provided with separate pushing surfaces acting to push a preceding closure element when a pushing force is exerted on the closure elements.

17. The roof assembly for use in the vehicle according to claim 1.

18. A roof assembly for use in the vehicle according to claim 14.
